(19) United States
(12) Patent Application Publication
(10) Pub. No.: US 2022/0070882 A1
(43) Pub. Date: Mar. 3, 2022

(54) WIRELESS COMMUNICATION APPARATUS AND METHOD

(71) Applicant: KABUSHIKI KAISHA TOSHIBA, Tokyo (JP)

(72) Inventor: Toshihisa NABETANI, Kawasaki Kanagawa (JP)

(73) Assignee: KABUSHIKI KAISHA TOSHIBA, Tokyo (JP)

(21) Appl. No.: 17/178,297

(22) Filed: Feb. 18, 2021

(30) Foreign Application Priority Data
Aug. 28, 2020 (JP) 2020-144804

(51) Int. Cl. H04W 72/12

(52) U.S. Cl. CPC H04W 72/1215; H04W 88/10; H04W 72/1268; H04W 72/1252

(57) ABSTRACT

According to one embodiment, a wireless communication apparatus connected to a base station via a first network and connected to a terminal apparatus via a second network is provided. The wireless communication apparatus includes a receiver and a transmitter. The receiver is configured to receive a first signal representing that the terminal apparatus holds data to be transmitted, from the terminal apparatus at first timing and receive the data from the terminal apparatus at second timing. The first transmitter is configured to transmit a second signal requesting the base station to allocate a resource to transmit the data to the base station, to the base station after the first timing and before the second timing.

### CROSS-REFERENCE TO RELATED APPLICATIONS

This application, is based upon and claims the benefit of priority from Japanese Patent Application No. 2020-144804, filed Aug. 25, 2020, the entire contents of which are incorporated herein by reference.

### FIELD

Embodiments described herein relate generally to a wireless communication apparatus and a method.

### BACKGROUND

In the 4th generation (4G) mobile communications such as Long Term Evolution (LTE) and LTE-Advanced (LTE-A), the 5th generation (5G) mobile communications whose services have already been started, and the like, generally, when a wireless communication apparatus transmits data to a base station (that is, in the upstream direction), it requests the bass station to allocate a resource (uplink resource) to transmit the data.

Allocating a resource to the wireless communication apparatus in response to a request from the wireless communication apparatus, the wireless communication apparatus can transmit data to the base station.

If, however, the wireless communication apparatus requests the base station to allocate a resource when data to be transmitted to the base station is generated in the wireless communication apparatus, the data transmission is delayed due to the allocation of the resource and thus cannot be performed efficiently.

### BRIEF DESCRIPTION OF THE DRAWINGS

FIG. 1 is a diagram showing an example of a configuration of a network system including a wireless communication system according to an embodiment,

FIG. 2 is a block diagram showing an example of a configuration of the wireless communication apparatus.

FIG. 3 is a sequence chart showing an example of the operation of a network system in a comparative example of the embodiment.

FIG. 4 is a sequence chart showing an example of the operation, of the network system in the comparative example of the embodiment when a first resource has already been allocated.

FIG. 5 is a sequence chart showing an example of the operation of the network system according to the embodiment.

FIG. 6 is an illustration of second buffer information.

FIG. 7 is a sequence chart showing an example of the operation of the network system when uplink data is not received from a terminal apparatus at a timing of transmission of data to a base station.

FIG. 8 is a sequence chart showing an example of the operation of the network system when the terminal apparatus is controlled so that a timing of data reception from the terminal apparatus is earlier than a timing of data transmission to the base station.

### DETAILED DESCRIPTION

In general, according to one embodiment, a wireless communication apparatus communicably connected to a base station via a first network and communicably connected to a terminal apparatus via a second network other than the first network is provided. The wireless communication apparatus includes a receiver and a transmitter. The receiver is configured to receive a first signal representing that the terminal apparatus holds data to be transmitted, from the terminal apparatus at first timing and receive the data from the terminal apparatus at second timing after the first timing. The first transmitter is configured, to transmit a second signal requesting the base station to allocate a resource to transmit the data to the base station, to the base station after the first timing and before the second timing.

Various embodiments will be described hereinafter with reference to the accompanying drawings.

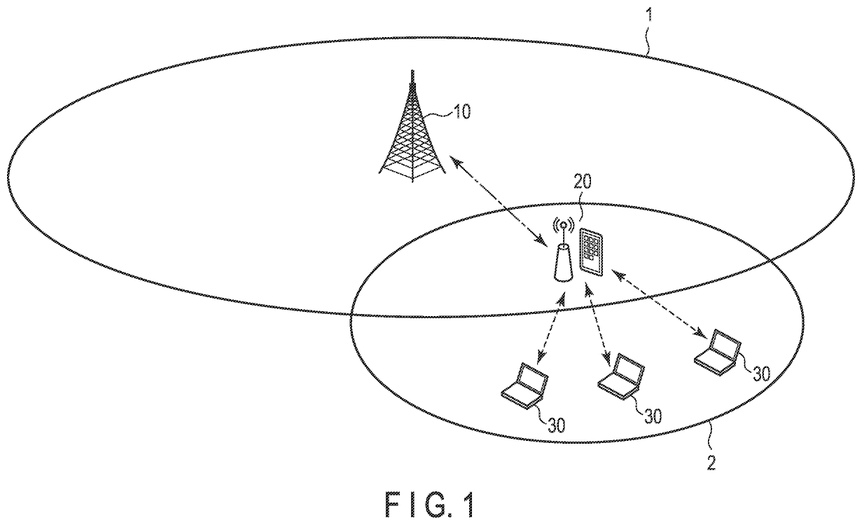

First, an example of a configuration of a network system including a wireless communication apparatus according to the present embodiment will be described with reference to FIG. 1.

The network system shown in FIG. 1 is configured by a first network 1 and a second network 2 and includes a base station 10, a wireless communication apparatus 20 and terminal apparatuses 30.

It is assumed in the present embodiment that the first network 1 is a wireless network for mobile communication (mobile communication network) and the second network 2 is a wireless network such as a wireless LAN (wireless LAN network).

The first network 1 is formed with the base station (cellular base station) 10 centered, and the wireless communication apparatus 20 is communicably connected to the base station 10 via the first network 1. The wireless communication apparatus 20 operates as (user equipment) UE in the first network 1.

It is assumed that in the first network 1, the base station 10 and the wireless communication apparatus 20 communicate with each other in accordance with the communication standard conforming to the third generation partnership project (3GPP) (e.g., a communication system defined in 4G or 5G).

The wireless communication apparatus 20 is communicably connected to a plurality of terminal apparatuses 30 (wireless LAM terminals) via the second network 2. Assume in this case that the wireless communication apparatus 20 has a function of operating as an access point (AP) in the wireless LAN (referred to as an access point function hereinafter).

It is assumed that in the second network 2, the wireless communication apparatus 20 and the terminal apparatuses 30 communicate with each other in accordance with the communication standard conforming to IEEE 802.11 (e.g., a communication system defined in IEEE 802.11ax). IEEE 802.11ax is also referred to as Wi-Fi6.

According to the network system described above, for example, each of the terminal apparatuses 30 generates data and transmits it to the wireless communication apparatus 20 via the second network 2. Then, the wireless communication apparatus 20 transmits the data to the base station 10 via the first network 1. In the following description, data to be transmitted by the terminal apparatuses 30 will be referred to as uplink data for convenience.

On the other hand, the base station 10 transmits downlink data (which is to be transmitted from the base station 10 to the terminal apparatuses 30) to the wireless communication apparatus 20 via the first network. Then, the wireless communication apparatus 20 transmits the downlink data to the terminal apparatuses via the second network 2.

In the present embodiment, the wireless communication apparatus 20 fulfills the function of a bridge between the base station 10 and the terminal apparatuses 30.

In the example shown in FIG. 1, only one wireless communication apparatus 20 is shown, but in the first network 1, a terminal apparatus other than the wireless communication apparatus 20 operating as UE may be provided. This terminal apparatus may have an access point function as the wireless communication apparatus 20, or may not have the access point function but only a function of operating as UE in the first network 1.

In the example shown in FIG. 1, three terminal apparatuses 30 are shown, but in the second network 2, at least one terminal apparatus 30 has only to be provided.

The present embodiment has been described in which the base station 10 and the wireless communication apparatus 20 communicate with each other in accordance with the communication system defined in 4G or 5G. However, they can be configured to communicate with each other in accordance with another communication system.

The present embodiment has also been described in which the wireless communication apparatus 20 and the terminal apparatuses 30 communicate with each other in accordance with the communication system, defined in IEEE 802.11ax. However, they can be configured to communicate with each other in accordance with another communication system.

In other words, if, in the present embodiment, the wireless communication apparatus 20 is communicable with the base station 10 via the first network. 1 and also communicable with the terminal apparatuses 30 via the second, network 2 other than the first network 1, any the communication systems applied to the first and second networks 1 and 2 are not limited,

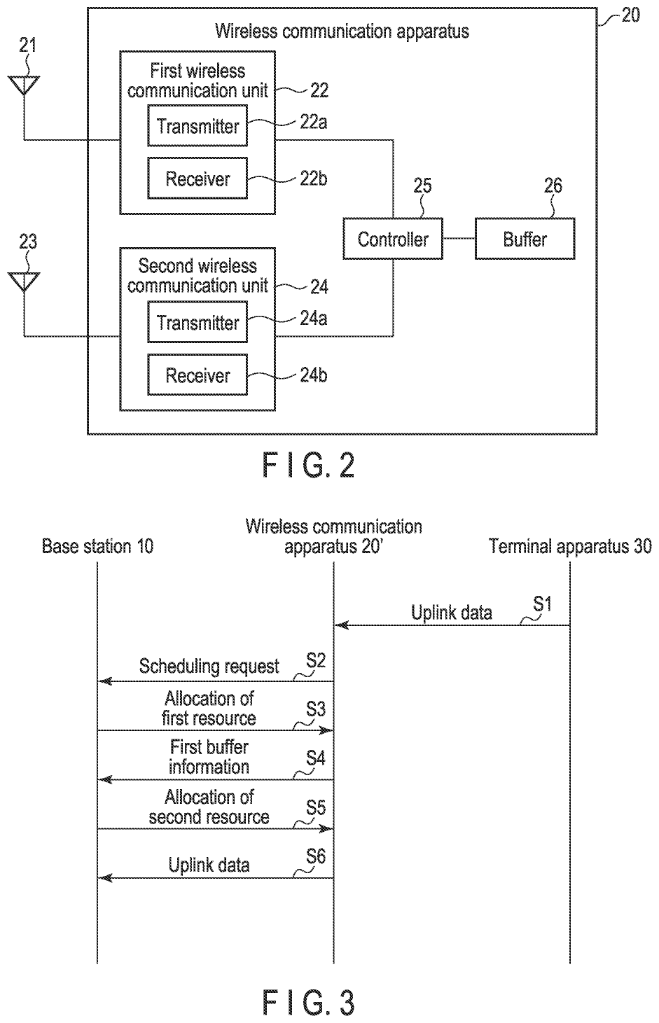

FIG. 2 shows an example of a configuration of the wireless communication apparatus 20 according to the present embodiment. As shown in FIG. 2, the wireless communication apparatus 20 includes a first antenna 21, a first wireless communication unit 22, a second antenna 23, a second wireless communication unit 24, a controller 25 and & buffer 26.

The first and second wireless communication units 22 and 24 shown in FIG. 2 are implemented by, for example, a wireless communication device included in the wireless communication apparatus 20. Specifically, the first and second wireless communication units 22 and 21 may be implemented by physically the same semiconductor chip or a plurality of semiconductor chips. A semiconductor chip for implementing the first and second wireless communication units 22 and 21 may be a chip having a communication function conforming to a single standard or a combo chip having a communication function conforming to a plurality of standards.

The controller 25 is implemented by, for example, a processor included in the wireless communication apparatus 20. The buffer 26 may be implemented by a memory included in the wireless communication apparatus or by a storage device such as a solid state drive (SSD) and a hard disk drive (HDD). If the buffer 26 is implemented by a memory, the memory may be a volatile memory such as a DRAM or a nonvolatile memory such as a RAND flash memory and an MRAM.

The first antenna 21 is formed of at least one antenna element to perform communication (mobile communication) via the first network 1.

The first wireless communication unit 22 includes a transmitter 22a and a receiver 22b to communicate with the base station 10 using the first antenna 21. The transmitter 22a performs a necessary process such as modulation, D/A conversion and frequency conversion for data to be transmitted to the base station 10, and transmits the data to the base station 10 via the first antenna 21. The receiver 22b performs a necessary process such as frequency conversion, A/D conversion and demodulation for the data received from the base station 10 via the first antenna 21. The data received by the receiver 22b is transmitted to the terminal apparatuses 30 by the second wireless communication unit 24, for example.

The second antenna 23 is formed of at least one antenna element to perform communication (wireless LAN communication) via the second network 2.

The second wireless communication unit 24 includes a transmitter 24a and a receiver 24b to communicate with the terminal apparatuses 30 using the second antenna 23. The transmitter 24a performs a necessary process such as modulation, D/A conversion and frequency conversion for data to be transmitted to the terminal apparatuses 30, and transmits the data to the terminal apparatuses 30 via the second antenna 23. The receiver 24b performs a necessary process such as frequency conversion, A/D conversion and demodulation for the data received from the terminal apparatuses 30 via the second antenna 23. The data received by the receiver 24b is transmitted to the base station 10 by the first wireless communication unit 22, for example.

In the present embodiment, at least one first antenna 21 and at least one second antenna 23 are not shared with each other to communicate with the base station 10 and the terminal apparatuses 30.

The controller 25 performs control necessary for mobile communication and wireless LAN communication. The controller 25 also performs control between the mobile communication and the wireless LAN communication. Specifically, the controller 25 performs control, for example, to transmit data from the terminal apparatuses 30 to the base station 10. The controller 25 also performs control, for example, to transmit data from the base station 10 to the terminal apparatuses 30. In addition, the controller 25 performs control, for example, for timing with which various requests are transmitted to the base station 10 and the terminal apparatuses 30.

The buffer 26 stores data received from the terminal apparatuses 30 (data to be transmitted to the base station 10) and data received from, the base station 10 (data to be transmitted to the terminal apparatuses 30) as described above. The buffer 26 may store data generated in the wireless communication apparatus 20 (data to be transmitted from the wireless communication apparatus 20 to the base station 10 or the terminal apparatuses 30).

The first and second antennas 21 and 23 have been described as separate antennas in the present embodiment. However, they may be implemented as at least one antenna common to communication performed via the first network 1 (communication with the base station 10) and communication performed via the second network 2 (communication with the terminal, apparatuses 30).

Below is a description of the operation of a network system including the wireless communication apparatus 20 according to the present embodiment. The operation of the network system, which is performed when the terminal apparatuses 30 transmit data to the base station 10 (uplink transmission), will, be mainly described.

First, an example of the operation of a network system according to a comparative example of the present embodiment will be described with reference to the sequence chart of FIG. 3. The network system in the comparative example will be described as including a wireless communication apparatus 20′ in place of the foregoing wireless communication apparatus 20 according to the present embodiment.

Assume here that uplink data is generated from the terminal apparatus 30 which is communicably connected to the wireless communication apparatus 20′ of the comparative example via the second network 2.

In this case, the terminal apparatus 30 transmits the uplink data to the wireless communication apparatus 20′ via the second network 2 (step S1).

Upon receiving the uplink data transmitted in step S1, the wireless communication apparatus 20′ determines the presence of data to be transmitted to the base station 10. The uplink data received by the wireless communication apparatus 20′ is stored in a buffer corresponding to the buffer 26 shown in FIG. 2.

The wireless communication apparatus 20′ is communicable connected to the base station 10 via the first network 1. To transmit data to the base station 10, resources (wireless resources) for transmitting the data needs to be allocated to the wireless communication apparatus 20′. The resources include a frequency band, a communication time period (referred to as a time slot hereinafter) and the like in which the wireless communication apparatus 20′ is available.

The wireless communication apparatus 20′ thus transmits a signal (referred to as a scheduling request) for requesting the allocation of resources, to the base station 10 (step S2).

When the process of step 32 is performed, the base station 10 schedules the allocation of resources to the wireless communication apparatus 20′ based on the scheduling request transmitted in step S2 to allocate the wireless communication apparatus 20′ a resource (referred to as a first resource hereinafter) for transmitting a signal (referred to as first buffer information hereinafter) regarding a buffer included in fine wireless communication apparatus 20′ (step S3). The first buffer information is referred to as, for example, a buffer status report (BSR).

When the process of step S3 is performed, the wireless communication apparatus 20′ transmits the first buffer information (BSR) to the base station 10 based on the first resource allocated in step S3 (step S4).

The first buffer information transmitted in step S4 is information capable of recognizing that the buffer included in the wireless communication apparatus 20′ stores data to be transmitted to the base station 10 (the wireless communication apparatus 20′ holds uplink data). The first buffer information includes, for example, information on the amount (size) of uplink data and a traffic type (data type).

Then, based on the first buffer information (amount of uplink data) transmitted in step S4, the base station 10 allocates a resource for transmitting the uplink data (referred to as a second resource hereinafter) to the wireless communication apparatus 20′ (step S5).

When the process of step S5 is performed, the wireless communication apparatus 20′ transmits the uplink data stored in the buffer to the base station 10 based on the second resource allocated in step S5 (step S6).

In the comparative example of the present embodiment, the uplink data generated in the terminal apparatus 30 (data to be transmitted by the terminal apparatus 30) can be transmitted to the base station 10 by performing the process shown in FIG. 3.

The scheduling request and the first buffer information have only to be transmitted using predetermined physical channels. The physical channels include, for example, a physical, uplink control channel (PUCCH) and a physical uplink shared channel (PUSCH).

It has been described in FIG. 3 that the wireless communication apparatus 20′ transmits the scheduling request and the first buffer information to the bass station 10. For example, there is a case where before the process shown in FIG. 3 is performed, the wireless communication apparatus 20′ has already transmitted other uplink data to the base station 10 (in other words, the first and second resources have already been allocated). In this case, the amount of uplink data transmitted from the terminal apparatus 30 to the wireless communication apparatus 20′ in step 31 differs from the amount of other uplink data already transmitted. It is thus necessary to allocate the second resource again, but the first resource (resource for transmitting first buffer information to the base station 10) can be used again.

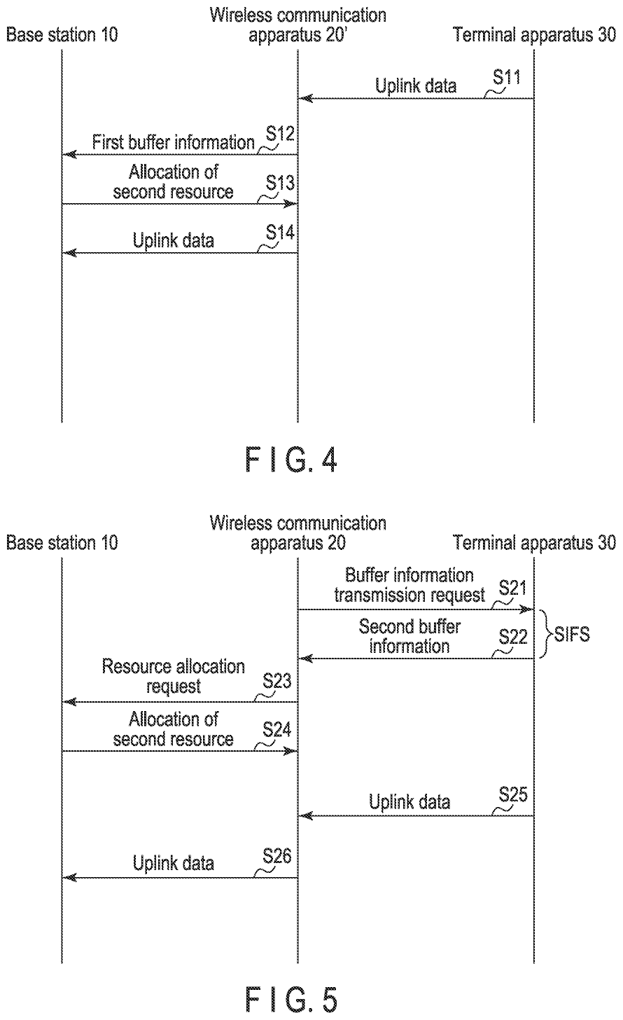

Therefore, when the wireless communication apparatus 20′ has previously transmitted other uplink data to the base station 10 and the base station has already allocated the first resource to the wireless communication apparatus 20′ (a scheduling request has already been made), the processes of steps S11 to 314 shown in FIG. 4 are performed in place of the process shown in FIG. 3. Note that the process shown in FIG. 4 corresponds to the step shown in FIG. 3 from which the processes of steps S2 and S3 are deleted, and the processes of steps S11 to S14 shown in FIG. 1 correspond to those of steps S1 and S4 to S6 shown in FIG. 3.

According to the process shown in FIG. 1, if a scheduling request has already been made when uplink data is transmitted from the terminal apparatus 30, the first buffer information can be transmitted using the first resource allocated based on the scheduling request.

In the following description, a signal to be transmitted from the wireless communication apparatus 20 to the base station 10 in order to transmit the uplink data, which is transmitted from the terminal apparatus 30, to the base station 10, will be referred to as a resource allocation request (message). For example, a resource allocation request which is made when the process shown in FIG. 3 is performed, is the scheduling request and the first buffer information, and a resource allocation request which is made when the process shown in FIG. 1 is performed, is the first buffer information. However, the resource allocation request may differ in contents from the scheduling request and the first buffer information as long as the resource allocation request is to request the base station 10 to allocate resources for transmitting the uplink data.

When the process shown in FIG. 3 or 4 is performed, the resource allocation request is transmitted to the base station 10 after the terminal apparatus 30 receives the uplink data. In other words, the wireless communication apparatus 20′ cannot recognize the presence of uplink data except when the uplink data is generated in the wireless communication apparatus 20′ (when the uplink data is received from the terminal apparatus 30 and stored in the buffer). Thus, the timing with which the resource allocation request is transmitted is later than the timing with which the uplink data is received from, the terminal apparatus 30.

In the foregoing comparative example, therefore, a delay from the reception of uplink data from the terminal apparatus 30 to the transmission of the uplink data to the base station 10 is long.

An example of the operation of the network system according to the present embodiment will be described below with reference to the sequence chart of FIG. 5.

In the present embodiment, the wireless communication apparatus 20 (transmitter 24a) transmits a signal for inquiring whether the terminal apparatus 30 holds uplink data (referred to as a buffer information transmission request hereinafter) to the terminal apparatus 30 via the second network 2 (step S21).

Assume here that the terminal apparatus 30 includes a buffer as the wireless communication apparatus 20, and the buffer stores the uplink data generated in the terminal apparatus 30.

In this case, in response to the buffer information transmission request in step S21, the terminal apparatus 30 transmits a signal regarding the buffer included in the terminal apparatus 30 (referred to as second buffer information hereinafter) to the wireless communication apparatus 20 (notifies the apparatus 20 of the signal) (step S22).

The second buffer information is information capable of recognising whether the buffer included in the terminal apparatus 30 stores uplink data (whether the terminal apparatus 30 holds uplink data). The second buffer information may be referred to as, for example, a buffer status report, but differs from the first buffer information (BSR) transmitted from the wireless communication apparatus 20 to the base station 10 via the first network 1.

The mechanism by which the terminal apparatus 30 (wireless LAN terminal) notifies the wireless communication apparatus 20 (wireless LAN access point) of information regarding the buffer included in the terminal apparatus 30 (second buffer information), is defined in the wireless LAN standard (IEEE 802.11ax). This mechanism is used in the present embodiment.

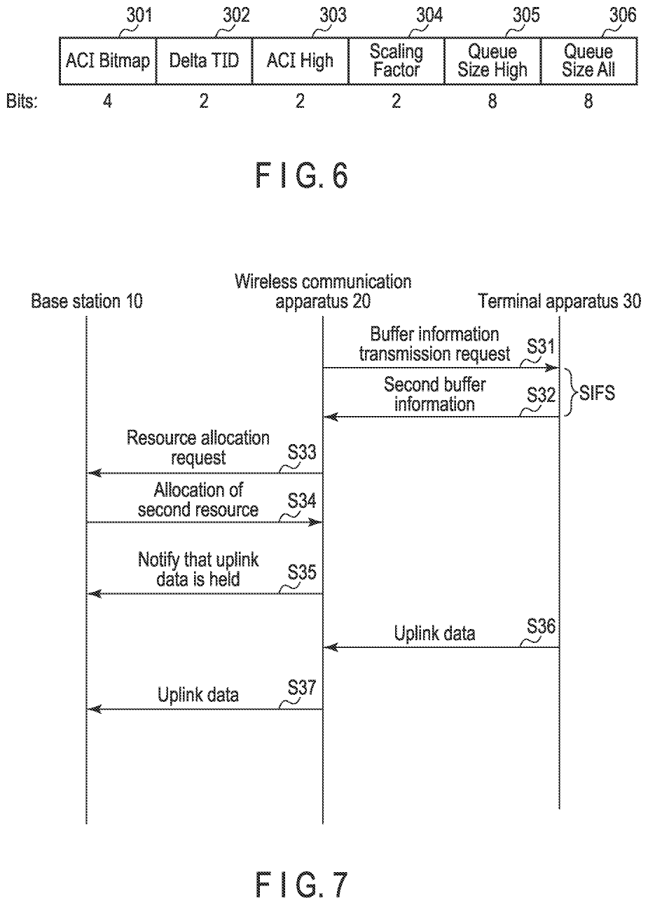

The second, buffer information transmitted from the terminal apparatus 30 to the wireless communication apparatus 20 based on the IEEE 802.11ax will foe described with reference to FIG. 6.

FIG. 6 shows an ACI Bitmap field 301, a Delta TID field 302, an ACI High field 303, a Scaling Factor field 303, a Queue Size High field 303 and a Queue Size All field 306. The second buffer information is transmitted from the terminal apparatus 30 to the wireless communication apparatus 20 in the form of a frame including the fields 301 to 306 in a MAC header.

The ACI Bitmap field 301 stores 4-bit information. The Delta TID field 302, ACI High field 303 and Scaling Factor field 304 each store 2-bit information. The Queue Size high field 305 and Queue Size All field 306 each store 8-bit information.

Assuming here that wireless communication between the wireless communication apparatus 20 and the terminal, apparatus 30 is performed in accordance with the communication method defined in IEEE 802.11ax, the Trigger frame defined in IEEE 802.11ax can be used as the buffer information transmission request (frame). When the buffer information transmission request is transmitted from the wireless communication apparatus to the terminal apparatus 30 using the Trigger frame, a Qos Null frame can foe used as a frame for notifying the wireless communication apparatus 20 of the second buffer information. In this case, the information shown in FIG. 6 is included in the MAC header of the QoS Null frame.

The second buffer information (Qos Null frame) is transmitted from the terminal apparatus 30 to the wireless communal cat ion apparatus 20 after a lapse of a predetermined time called short inter frame space (SIFS) defined by IEEE 802.11ax after the buffer information transmission request (Trigger frame) is transmitted.

When the second network 2 includes a plurality of terminal apparatuses 30, the wireless communication apparatus 20 can designate one of the terminal apparatuses 30, to which the second buffer information is requested, to be transmitted in the buffer information transmission request (Trigger frame). The second buffer information may be requested to be transmitted to a plurality of terminal apparatuses 30.

According to the foregoing configuration, the wireless communication apparatus 20 can transmit the buffer information transmission request to receive the second buffer information from an optional terminal apparatus 30 with optional timing.

It has been described that the Trigger frame is used to make a buffer information transmission request and the Qos Null frame is used to make a notification of the second buffer information. A frame of another format may be used to make a buffer information transmission request and make a notification of the second buffer information notification.

Returning to FIG. 5 again, the wireless communication apparatus 20 (receiver 23b) receives the second buffer information transmitted in step S22.

The second buffer information makes it possible to determine whether the terminal apparatus 30 holds uplink data. If it is determined based on the second buffer information transmitted in step S22 that the terminal apparatus 30 does not hold uplink data, the process of FIG. 5 is terminated.

If it is determined based on the second buffer information transmitted in step S22 that the terminal apparatus 30 holds uplink data, the wireless communication apparatus 20 (transmitter 22a) transmits a resource allocation request to the base station 10 (step S23).

The second buffer information includes, for example, the presence or absence of uplink data (data to be transmitted) and the amount of uplink data (information of the amount). Assume that it can be determined by receiving the uplink data from the terminal apparatus 30 whether the uplink data should be transferred to the base station 10. It may be assumed that upon receiving the second buffer information, the wireless communication apparatus 20 may transfers ail the uplink data to be received to the base station 10, and it may be assumed that only a certain percentage of the uplink data is transferred to the base station 10. These assumptions may be set on the basis of operational constraints and rules of a system to be used, past statistical information, or the like. Alternatively, they may be set on the basis of various items of environmental information such as a terminal apparatus that has transmitted uplink data, a time period for which the uplink data (or second buffer information) is received, and timing associated with the occurrence of some event.

The second buffer information may further include necessity of transfer to the base station 10 (information of necessity). The second buffer information makes it possible to determine whether uplink data needs to be transferred to the base station 10 when the second buffer information is received. Thus, the wireless communication apparatus 20 has only to transmit a resource allocation request to the base station 10 when it determines that the uplink data is transferred to the base station 10.

Assuming here that the wireless communication apparatus 20 is notified of the second buffer information in the form, of a frame including the fields 301 to 306 shown in FIG. 6 in the MAC header, the wireless communication apparatus 20 can refer to the ACI Bitmap field 301 and the Delta TID field 302 to determine the traffic type of the uplink data stored in the buffer included in the terminal apparatus 30 and the number of traffics. The wireless communication apparatus 20 can also refer to the Scaling Factor field 301 to determine a unit of the number of traffics regarding the uplink data stored in the buffer included in the terminal apparatus 30. The wireless communication apparatus 20 can also refer to the Queue Size High field 305 and the Queue Size Ail field 306 to determine the number of traffics (amount of data) in the unit transmitted in the Scaling Factor field 304 for each traffic type.

According to the above, the second buffer information includes information on the data amount and the traffic type. Based on the second buffer information, the wireless communication apparatus 20 can acquire (collect) the data amount (transmit buffer amount) of uplink data, which is stored in the buffer included in the terminal apparatus 30, for each traffic type.

In step 323, a resource allocation request (first buffer information) including the data amount acquired for each traffic type based on the second buffer information as described above is transmitted to the base station 10.

Assuming that the process shown in FIG. 5 is performed with the above scheduling request not made, the process of step S23 corresponds to the processes of steps S2 to S4 shown in FIG. 3 except that the first buffer information including the data amount acquired for each traffic type based on the second buffer information is transmitted to the base station 10.

On the other hand, assuming that the process shown in FIG. 5 is performed with the scheduling request made, the process of step S23 corresponds to the process of step S12 shown in FIG. 4 except that the first buffer information including the data amount acquired for each traffic type based on the second buffer information is transmitted to the base station 10.

When the process of step S23 is performed, the base station 10 allocates a second resource to the wireless communication apparatus 20 in order to transmit, uplink data later from the terminal apparatus 30, based on the resource allocation request (data amount for each traffic type included in the first buffer information) transmitted in step S23 (step S24). In step S24, for example, the wireless communication apparatus 20 is notified of a time slot, for which the wireless command, cat ion apparatus 20 transmits the uplink data to the base station 10 (timing of transmission of the data) as scheduling information. The scheduling information is transmitted from the base station 10 to the wireless communication apparatus 20 using, for example, a physical downlink control channel (PDCCH).

There is a case where when the first network 1 is a wireless network of 5G mobile communication, a network slice technology may be applied to wireless communication between the base station 10 and the wireless communication apparatus 20. The network slice technology is a technology capable of setting a plurality of logical sections (network slices) on a common resource placed in a network to allow the network slices to be operated independently of each other.

Assume that the foregoing network slice technology is applicable. For example, when there are a number of traffic types for the uplink data transmitted later from the terminal apparatus 30, the wireless communication apparatus 20 (controller 25) can determine that the network slices are generated. In this case, the wireless communication apparatus 20 may transmit/receive a series of messages (fifth signal) for forming a new (additional) radio bearer to/from the base station 10 (exchange the messages between them), in addition to the resource allocation request transmitted to the base station 10 in step S23.

A plurality of radio bearers may be formed depending on the number of traffic types. In this case, the resource allocation may be requested for each of the radio bearers or may be requested collectively for the radio bearers.

Assume here that the terminal apparatus 30 transmits the uplink data stored in the buffer included in the terminal apparatus 30 to the wireless communication apparatus 20 (step 325). In step 325, the uplink data transmitted from the terminal apparatus 30 is received by the wireless communication apparatus 20 (receiver 24b).

Since the second resource has already been allocated in step S24, the wireless communication apparatus 20 (transmitter 22a) can transmit the uplink data received by the receiver 24b to the base station 10 with a short delay using the resource allocated in step S24 (step S26).

It has been described that in the example shown in FIG. 5, the second buffer information may be transmitted from the terminal apparatus 30 to the wireless communication apparatus 20 in response to the buffer information transmission request. The second buffer information may foe spontaneously transmitted from the terminal apparatus 30 without receiving the buffer information transmission request.

The resource allocation request in step S23 may be transmitted to the base station 10 with the timing at which the second buffer information is received from at least one terminal apparatus 30 as a trigger. For example, when the second buffer information is received from a plurality of terminal apparatuses 30, a resource allocation request based on the second buffer information (data amount and traffic type) from the terminal apparatuses 30 may be transmitted in a comprehensive manner (a resource allocation request is made to transmit the uplink data held by the terminal apparatuses 30).

As described above, in the pure sent embodiment, after receiving from the terminal apparatus 30 the second buffer information (first signal) representing that the terminal apparatus holds data to be transmitted (uplink data), the wireless communication apparatus 20 receives the uplink data from the terminal apparatus 30.

In the following description, the timing (first timing) at which the wireless communication apparatus 20 receives the second buffer information from the terminal apparatus 30 will be referred to as buffer information reception timing, and the timing at which the wireless communication apparatus 20 receives the uplink data from the terminal apparatus 30 (second timing) will be referred to as data reception timing.

In the present embodiment, a resource allocation request (second signal) which requests resource allocation to transmit uplink data to the base station 10 is transmitted to the base station 10 after the buffer information reception timing and before the data reception timing.

The foregoing configuration makes it possible to transmit data to the base station 10 with efficiency.

Specifically, in the present embodiment, the use of the second buffer information transmitted from the terminal apparatus 30 to the wireless communication apparatus 20 allows the wireless communication apparatus 20 to determine the presence of the uplink data before it actually receives the uplink data from One terminal apparatus 30 (in other words, to determine that it receives the uplink data later from the terminal apparatus 30).

The wireless communication apparatus 20 can thus transmit the resource allocation request to the base station 10 using the reception of the second buffer information from the terminal apparatus 30 as a trigger.

In the present embodiment, the wireless communication apparatus 20 can transmit the resource allocation request to the base station 10 before the apparatus 20 actually receives the uplink data. The wireless communication apparatus 20 can thus receive the uplink data from the terminal apparatus 30 and then transmit it to the base station 10 with a short delay.

In the present embodiment, the wireless communication apparatus 20 transmits the resource allocation request including a data amount (and a traffic type) of uplink data acquired from the second buffer information to the base station 10 as described above. The base station 10 can thus allocate the wireless communication apparatus 20 an appropriate resource (second resource) corresponding to the data amount.

In the present embodiment, the wireless communication apparatus 20 may receive the second buffer information (third and fourth signals) from a plurality of terminal apparatuses 30 and request the base station 10 to allocate resources based on the second buffer information. This configuration allows the base station 10 to allocate the resources to the wireless communication apparatus 20 with efficiency.

In the present embodiment, the wireless communication apparatus 20 includes at least one antenna common to communication with the base station 10 and communication with the terminal apparatuses 30. In this case, the wireless communication apparatus 20 can save a space required for implementing the antenna and can decrease in cost due to a reduction of the number of hardware components.

The wireless communication apparatus 20 includes the first antenna 21 to communicate with the base station 10 and the second antenna 22 to communicate with the terminal apparatus 30 as shown in FIG. 2. In this case, the wireless communication apparatus 20 can improve in the degree of freedom of design and decrease in cost due to facilitation of implementation.

Furthermore, in the present embodiment, the second wireless communication unit 24 (receiver 24b) may be built in a second semiconductor chip, and the first wireless communication unit 22 (transmitter 22a) may be incorporated in a first semiconductor chip other than the second semiconductor chip. Assume in this configuration that the uplink data received by the receiver 24b is temporarily stored in a memory provided outside the first and second semiconductor chips and then transmitted by the transmitter 22a. Thus, a host processor which connects an IEEE 802.11ax chip and a 5G chip can relay the uplink data using an external memory as a buffer without using a single semiconductor chip (combo chip) having both functions of IEEE 802.11ax communication and 5G communication, for example.

Assume that when the first wireless communication unit 22 (transmitter 22a) and the second wireless communication unit 24 (receiver 24b) are built in a single semiconductor chip, the uplink data received by the receiver 24b is temporarily stored in a memory built in the single semiconductor chip and then transmitted by the transmitter 22a. In this assumption, in a single semiconductor chip (combo chip) having both functions of IEEE 802.11ax communication and 5G communication, a built-in memory can be used to mediate between the two different communications with efficiency.

Even though the first wireless communication unit 22 (transmitter 22a) and the second wireless communication unit 24 (receiver 24b) are built in a single semiconductor chip as described above, the uplink data received by the receiver 24b may be temporarily stored in a memory provided outside the single semiconductor chip and then transmitted by the transmitter 22a. This configuration allows an external memory to mediate between the two different communications without making a large change in implementation inside a single semiconductor chip (combo chip) having both functions of IEEE 802.11ax communication and 5G communication.

Assume here that a scheduling request has already been made as described above before, for example, the process of FIG. 5 is performed and a first resource (e.g., PUSCH) is allocated to the wireless communication apparatus 20. In this case, the base station 10 notifies the wireless communication apparatus 20 of a time slot in which the wireless communication apparatus 20 transmits the first buffer information, as scheduling information, and the wireless communication apparatus 20 transmits a resource allocation request (first buffer information) with timing (fourth timing) corresponding to the time slot.

The present embodiment has been described in which the terminal apparatus 30 transmits the second buffer information to the wireless communication apparatus 20 in response to a buffer information transmission request (eighth signal for inquiring whether the terminal apparatus 30 holds data to be transmitted) which is transmitted from the wireless communication apparatus 20. When the base station 10 notifies the wireless communication apparatus 20 of timing with which the resource allocation request is transmitted (referred to as resource allocation request timing hereinafter) as described above, before the resource allocation request is transmitted to the base station 10, it is assumed that the wireless communication apparatus 20 transmits the buffer information transmission request to the terminal apparatus 30 such that it can receive the second buffer information from the terminal apparatus 30 prior to the resource allocation request timing.

The second buffer information is received after a lapse of predetermined time (time referred to as SIFS) after the buffer information transmission request (trigger time) is transmitted from the wireless communication apparatus 20 to the terminal apparatus 30. The timing with which the buffer information transmission request is transmitted, has only to be determined by considering the time (by calculating the time backward).

The foregoing configuration makes it possible to receive the second duffer information by the resource allocation request timing transmitted from the base station 10. The resource allocation request can thus be transmitted efficiently with the resource allocation request timing.

In the present embodiment, the base station 10 allocates a resource (second resource) for transmitting the uplink data to the wireless communication apparatus 20 and then the wireless communication apparatus 20 receives the uplink data as described with reference to FIG. 5. When the base station 10 allocates the second resource to the wireless communication apparatus 20, the base station 10 notifies the wireless communication apparatus 20 of a time slot (timing corresponding to the time slot) in which the wireless communication apparatus 20 transmits the uplink data to the base station 10.

In the above case, at the timing when the wireless communication apparatus 20 transmits uplink data, which corresponds to the time slot notified from the base station 10, to the base station 10 (hereinafter referred to as data transmission timing), the wireless communication apparatus 20 may not receive the uplink data from the terminal apparatus 30, depending on the timing when the second resource is allocated and the timing when the uplink data is received from the terminal apparatus 30 (data reception timing).

An example of the operation of the network system according to the present embodiment in which the wireless communication apparatus 20 does not receive uplink data from the terminal apparatus 30 at the data transmission timing, will be described with reference to the sequence chart shown in FIG. 7.

Assume first that the processes of steps S31 to S34 corresponding to steps S21 to S24 shown in FIG. 5 are performed. Accordingly, the second resource for transmitting uplink data transmitted from the terminal apparatus 30 is allocated to the wireless communication apparatus 20.

When the second resource is allocated to the wireless communication apparatus 20 as described above, the base station 10 notifies the wireless communication apparatus 20 of the data transmission timing (time slot) as scheduling information. It is assumed here that the wireless communication apparatus 20 does not receive uplink data from the terminal apparatus 30 at the data transmission timing.

When no uplink data is received at the data transmission timing, for example, a general wireless communication apparatus notifies the base station 10 that it does not hold the uplink data (the buffer does not store the uplink data). When the base station 10 is thus notified, it releases the allocation of the second resource.

When the uplink data is received from the terminal apparatus 30 after the second resource is released, resource allocation for transmitting the uplink data to the base station 10 has to be requested again (resource allocation request has to be transmitted again), which inhibits the data from being transmitted with efficiency.

In the present embodiment, as shown in FIG. 7, even though the wireless communication apparatus 20 does not hold uplink data, if it determines that the terminal apparatus 30 holds uplink data (the second buffer information is received), it is assumed that a signal that can recognise (represent) that the terminal apparatus 30 holds uplink data (hereinafter referred to as data hold notification) is transmitted from the wireless communal oat ion apparatus 20 (transmitter 22 a) to the base station 10 (step 335).

When the process of step 335 is performed, the processes of steps S36 and S37 corresponding to steps S25 and S26 shown in FIG. 5 have only to be performed.

In the present embodiment, as described above, when the base station 10 notifies the wireless communication apparatus 20 of data transmission timing (third timing) at which the wireless communication apparatus 20 transmits uplink data to the base station 10 by allocating the second resource to the wireless communication apparatus 20 based on the resource allocation request, and when the data transmission timing is after the buffer information reception timing (timing at which the second buffer information is received from the terminal apparatus 30) and before the data reception timing (timing at which the uplink data is received from the terminal apparatus 30), the wireless communication apparatus 20 transmits the data hold notification, (sixth signal) capable of recognizing that the wireless communication apparatus 20 holds the uplink data to the base station 10.

In the present embodiment, when the wireless communication apparatus 20 receives the second buffer information from the terminal apparatus 30, it can determine that it receives the uplink data from the terminal apparatus 30 later (generates data to be transmitted to the base station 10). Even though the wireless communication apparatus 20 does not hold the uplink data at the data transmission timing, it operates as holding the uplink data and transmits a data hold notification to the base station 10.

The above configuration makes it possible to avoid releasing the second resource allocated to the wireless communication apparatus 20 and thus maintain the allocation of the second resource. Data can thus be transmitted with efficiency without requesting resource allocation again.

It has been described here that the process shown in FIG. 7 is performed. The wireless communication apparatus 20 may be configured to transmit a data hold notification to the base station 10 at the data transmission timing when the second buffer information has already been received and when the uplink data has not been received at the data transmission timing.

It has also been described here that the wireless communication apparatus 20 transmits a data hold notification at the data transmission timing. For example, when the base station 10 does not receive the uplink data at the timing when the second resource is transmitted (allocated), the wireless communication apparatus 20 can be configured to notify the base station 10 that it doss not hold the uplink data at that timing. Even though the base station 10 receives the notification, the allocation of the second resource is released.

In the present embodiment, therefore, even though the wireless communication apparatus 20 does not receive the uplink data at the timing when the second resource is notified, if it determines that the terminal apparatus 30 holds the uplink data (it receives the second buffer information), it is assumed that the wireless communication apparatus 20 transmits a data hold notification to the base station 10 (performs the process of step S35).

However, according to the process shown in FIG. 7, for example, the wireless communication apparatus 20 transmits the resource allocation request to the base station 30 in step S33. It is also considered that transmitting the resource allocation request at this timing corresponds to transmitting the data hold notification described above. From this point of view, if a notification that the allocation of the second resource is released (secondary resource release available notification) is not transmitted to the base station 10, the wireless communication apparatus 20 may not transmit the foregoing data hold notification (in other words, the process of step S35 is omitted).

FIG. 7 is directed to the case where the wireless communication apparatus 20 does not receive the uplink data from the terminal apparatus 30 at the data transmission timing. In the present embodiment, the terminal apparatus 30 may be controlled such that the data reception timing at which the uplink data is received from the terminal apparatus 30 is earlier than the data transmission timing at which the uplink data is transmitted to the base station 10.

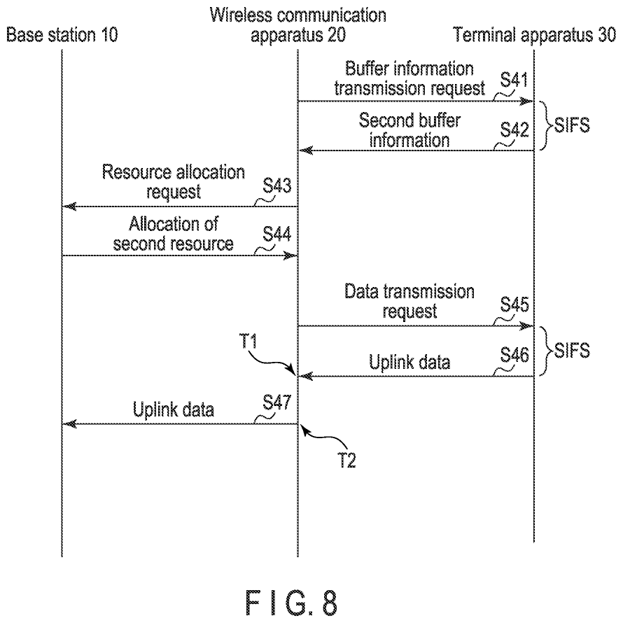

An example of the operation of the network system according to the present embodiment to control the terminal 30 such that the timing of data reception from the terminal 30 is earlier than the timing of data transmission to the base station 10, will be described below with reference to the sequence chart of FIG. 8.

First, the processes of steps S41 to S45 corresponding to steps S21 to S25 shown in FIG. 5 are performed.

When the process of step S44 is performed to allocate the second resource to the wireless communication apparatus 20, the base station 10 notifies the wireless communication apparatus 20 of the data transmission timing as scheduling information as described above.

The wireless communication apparatus 20 (transmitter 25a) transmits a data transmission request (data transmission request frame) requesting the transmission of uplink data to the terminal, apparatus under the control of the controller 25 (step S45). As the data transmission request frame, the Trigger frame defined in IEEE 802.11ax can be used like the buffer information transmission request frame described above.

When the Trigger frame is used as a buffer information transmission request frame and a data transmission request frame, the terminal apparatus 30 can identify the Trigger frame transmitted from the wireless communication apparatus 20 as the buffer information transmission request frame or the data transmission request frame, by storing an identifier for identifying each frame in a frame type (field) in the Trigger frame.

In step S45, when the wireless communication apparatus 20 transmits the data transmission request frame (Trigger frame) to the terminal apparatus 30, the terminal apparatus 30 transmits the uplink data after a predetermined time (referred to as SIFS) has elapsed (step S46).

When the process of step 346 is performed, the wireless communication apparatus 20 (receiver 24b) receives the uplink data transmitted in step S46.

The wireless communication apparatus 20 (transmitter 22a) can transmit the received uplink data to the base station 10 at the data transmission timing (step S47).

In the process shown in FIG. 8, a data transmission request (seventh signal) is transmitted to the terminal apparatus 30 such that the uplink data is received from the terminal apparatus 30 at data reception timing T1 before data transmission timing T2 notified from the base station 10 when the second resource is allocated in step 344. The uplink data is transmitted from the terminal apparatus 30 after a predetermined time has elapsed since the data transmission request is transmitted. The uplink data can thus be received from the terminal apparatus 30 in time for the data transmission timing, with the result that data can be transmitted with efficiency.

In the Trigger frame, in addition to the designation of a terminal apparatus 30 requesting the transmission of uplink data, a transmission time length can be designated when the terminal apparatus 30 transmits the uplink data. When the transmission time length is designated in the Trigger frame, the terminal apparatus 30 transmits the uplink data to the wireless communication apparatus 20 according to the transmission time length. In the present embodiment, therefore, not only the transmission timing of the data transmission request but also the transmission time length of the uplink data transmitted from the terminal apparatus 30 to the wireless communication apparatus 20 may be controlled further using the Trigger frame.

When the wireless communication apparatus 20 (controller 25) controls the transmission time length of the uplink data as well as the transmission timing of the data transmission request as described above, it can control the reception completion timing of the uplink data more accurately in the wireless communication apparatus 20.

When the wireless communication apparatus 20 controls only the transmission timing of the data transmission request as described above, the reception completion timing T1 of the uplink data is likely to exceed the data transmission timing T2 if the transmission time length of the uplink data is long. Controlling the transmission time length itself makes it possible to receive the uplink data reliably before the data transmission timing.

In the present embodiment, the above configuration makes it possible to avoid the fact that uplink data is not received, at the data transmission timing (in other words, the wireless communication apparatus 20 does not hold the uplink data) and thus transmit data more reliably and more efficiently.

It has been described that the transmission time length is controlled (designated) using the Trigger frame. In order to control the reception completion timing of the uplink data more accurately, for example, the transmission frame can be controlled further using the Trigger frame.

It has been described that the Trigger frame is used as the data transmission request in the present embodiment. For example, a frame of another form may be used as the data transmission request.

It has been described that the second network 2 is a wireless network such as a wireless LAN in the present embodiment. The second network may be a wireless network other than a wireless LAN. It has also been described that the wireless communication apparatus 20 has an access point function in the present embodiment. The wireless communication apparatus 20 has only to be a terminal apparatus having a function as a master station to transmit data (uplink data), which is generated in the terminal apparatus 30 included in the second network 2, to the base station 10.

According to the present embodiment, the wireless communication apparatus 20, which operates as a mobile communication terminal in mobile communication and a master station of a wireless system other than the mobile communication, determines the presence of uplink data in advance from the second buffer information before receiving the uplink data from a terminal apparatus 30 of the wireless system other than the mobile communication, and transmits a resource allocation request to the base station 10 based on the second buffer information. The uplink data can thus be transmitted efficiently to the base station 10 as a mobile communication terminal. The foregoing configuration in the present embodiment allows short-delay uplink communication to be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus communicably connected to a bass station via a first network and communicably connected to a terminal apparatus via a second network other than the first network, comprising:
a receiver configured to receive a first signal representing that the terminal apparatus holds data to be transmitted, from the terminal apparatus at first timing and receive the data from the terminal apparatus at second timing after the first timing; and
a first transmitter configured to transmit a second signal requesting the base station to allocate a resource to transmit the data to the base station, to the base station after the first timing and before the second timing.

2. The wireless communication apparatus of claim 1, wherein the first signal comprises information regarding an amount of data to be transmitted by the terminal apparatus.

3. The wireless communication apparatus of claim 2, wherein the second signal comprises information regarding the amount of data to be transmitted by the terminal apparatus.

4. The wireless communication apparatus of claim 1, wherein:
the apparatus is communicably connected to a first terminal apparatus and a second terminal apparatus via the second network;
the receiver is configured to receive a third signal representing that the first terminal apparatus holds data to be transmitted, from the first terminal apparatus, and receive a fourth signal representing that the second terminal apparatus holds data to be transmitted, from the second terminal apparatus; and
the first transmitter is configured to transmit the second signal to request the base station to allocate a resource based on the third signal received from the first terminal apparatus and the fourth signal received from the second terminal apparatus.

5. The wireless communication apparatus of claim 1, wherein the first transmitter is configured to transmit a fifth signal to the base station to form a new radio bearer after the first timing and before the second timing.

6. The wireless communication apparatus of claim 1, wherein when the base station allocates the resource to the apparatus based on the second signal to notify the apparatus of third timing at which the apparatus transmits the data to the base station, and when the third timing is after the first timing and before the second timing, the first transmitter is configured to transmit a sixth signal representing that the apparatus holds the data, to the base station at the third timing.

7. The wireless communication apparatus of claim 1, further comprising a controller configured to, when the base station allocates the resource to the apparatus based on the second signal to notify the apparatus of third timing at which the apparatus transmits the data to the base station, control the terminal apparatus such that the second timing is before the third timing.

8. The wireless communication apparatus of claim 7, wherein:
the controller is configured to transmit a seventh signal to the terminal apparatus to request the terminal apparatus to transmit the data such that the second timing is before the third timing; and
the receiver is configured to receive data from the terminal apparatus in response to the seventh signal transmitted from the controller.

9. The wireless communication apparatus of claim 8, wherein the data is transmitted from the terminal apparatus after a lapse of predetermined time after the seventh signal is transmitted.

10. The wireless communication apparatus of claim 8, wherein the controller is configured to control a transmission time length of data transmitted from the terminal apparatus to the apparatus using the seventh signal.

11. The wireless communication apparatus of claim 1, further comprising second transmitter configured to transmit an eighth signal to the terminal apparatus to inquire whether the terminal apparatus holds data to be transmitted, and
the receiver is configured to receive the first signal from the terminal apparatus in response to the eighth signal transmitted from the second transmitter.

12. The wireless communication apparatus of claim 11, wherein the first signal is transmitted from the terminal apparatus after a lapse of predetermined time after the eighth signal is transmitted.

13. The wireless communication apparatus of claim 11, wherein when the base station notifies the apparatus of fourth timing at which the apparatus transmits the second signal to the base station, the second transmitter is configured to transmit the eighth signal such that the first signal is received before the fourth timing.

14. The wireless communication apparatus of claim 1, further comprising at least one antenna common to communication with the base station and communication with the terminal apparatus.

15. The wireless communication apparatus of claim 1, further comprising:
at least one first antenna used to communicate with the base station; and
at least one second antenna used to communicate with the terminal apparatus,
wherein the one first antenna and the one second antenna are not common to communication with the base station and communication with the terminal apparatus.

16. The wireless communication apparatus of claim 1, wherein:
the receiver is built in a first semiconductor chip;
the first transmitter is built in a second semiconductor chip other than the first semiconductor chip; and
the data received by the receiver is stored temporarily in a memory provided outside the first semiconductor chip and the second semiconductor chip, and then transmitted by the first transmitter.

17. The wireless communication apparatus of claim 1, wherein:
the receiver and the first transmitter are built in a single semiconductor chip; and
the data received by the receiver is stored temporarily in a memory built in the single semiconductor chop and then transmitted by the first transmitter.

18. The wireless communication apparatus of claim 1, wherein:
the receiver and the first transmitter are built in a single semiconductor chip; and
the data received by the receiver is stored temporarily in a memory provided outside the single semiconductor chip and then transmitted by the first transmitter.

19. A wireless communication apparatus communicably connected to a base station via a first network and communicably connected to a terminal apparatus via a second network other than the first network, comprising:
a receiver configured to receive a first signal representing that the terminal apparatus holds data to be transmitted, from the terminal apparatus at first timing and receive the data from the terminal apparatus at second timing after the first timing; and
a transmitter configured to, when the base station allocates the apparatus a resource for transmitting the data to the base station to notify the apparatus of third timing at which the apparatus transmits the data to the base station, and when the third timing is after the first timing and before the second timing, transmit a sixth signal representing that the apparatus holds the data, to the base station at the third timing.

20. A method to be executed by a wireless communication apparatus communicably connected to a base station via a first network and communicably connected to a terminal apparatus via a second network other than the first network, comprising the steps of:
receiving a first signal representing that the terminal apparatus holds data to be transmitted, from the terminal apparatus at first timing and receiving the data from the terminal apparatus at second timing after the first timing; and
transmitting a second signal requesting the base station to allocate a resource to transmit the data to the base station, to the base station after the first timing and before the second timing.

21. A method to be executed by a wireless communication apparatus communicably connected to a base station via a first network and communicably connected to a terminal apparatus via a second network other than the first network, comprising the steps of:
receiving a first signal representing that the terminal apparatus holds data to be transmitted, from the terminal apparatus at first timing and receiving the data from the terminal apparatus at second timing after the first timing; and
when the base station allocates the apparatus a resource for transmitting the data to the base station to notify the apparatus of third timing at which the apparatus transmits the data to the base station, and when the third timing is after the first timing and before the second timing, transmitting a sixth signal representing that the apparatus holds the data, to the base station at the third timing.
